(19) United States
(12) Patent Application Publication
(10) Pub. No.: US 2004/0105919 A1
(43) Pub. Date: Jun. 3, 2004

(54) Processing system having a process injection apparatus

(75) Inventor: Keith A. Chisholm, Chattanooga, TN (US)

Correspondence Address: FITZPATRICK CELLA HARPER & SCINTO, 30 ROCKEFELLER PLAZA, NEW YORK, NY, 10112, US

(73) Assignee: Mars, Incorporated, McLean, VA (US)

(21) Appl. No.: 10/307,879

(22) Filed: Dec. 2, 2002

(51) Int. Cl. A23L 1/27

(52) U.S. Cl. 426/250

(57) ABSTRACT

A process injection apparatus, a method for supplying a process ingredient to a process apparatus, and a processing system using the process injection apparatus. The apparatus of the invention includes a process ingredient source and a process ingredient supply line. The process ingredient supply line has a first end and a second end, where the first end is in fluid communication with the process ingredient source, and the second end is configured and adapted for insertion into a process solution supply line of a process apparatus at a point upstream of a process vessel of the process apparatus, thereby providing an injection point in the process solution supply line. The process ingredient source and the injection point are in fluid communication through the process ingredient supply line, and the process injection apparatus is configured and adapted to supply a process ingredient from the process ingredient source, through the process ingredient supply line, and to the injection point for use in a process in the process vessel. The second end is configured to position the injection point sufficiently close to the process vessel, such that process ingredient flowing through the injection point is exposed to any process solution in the process apparatus for a period of time less than that required to significantly degrade the ingredient upon exposure to the solution.

### BACKGROUND OF THE INVENTION

1. Field of the Invention

The present invention generally relates to the timed introduction of a process ingredient into a process solution in a process. In particular, the invention relates to a method and apparatus for introducing a process ingredient into a process solution shortly before or as the ingredient is required in a process, thereby reducing exposure of the ingredient to conditions in the process solution that are potentially detrimental to the ingredient. The invention is particularly useful where the process ingredient and the process solution must be mixed prior to introduction into the process.

2. Related Prior Art

Conditions in process solutions, such as, e.g., temperature, acidity, and chemical reactivity, are known to prevent the use of certain compositions that would otherwise be useful in the process in which the process solution is used, as extended exposure to the process solution conditions degrades or decomposes such ingredients. For example, candies, other confectionaries, and pharmaceutical tablets and pills are often coated in a process known as panning. In a panning process, a mass of centers is coated by introducing a coating solution, such as, e.g., by spraying, dripping, pouring, and the like, into a rotating drum or coating pan containing the mass of centers. As the pan rotates, the coating solution is distributed uniformly onto the mass of centers, providing a uniform coating layer on each of the centers that is typically dried by a flow of drying gas. The process is repeated until a coating or shell of a desired thickness is obtained.

Where a sugar coating or shell is applied in a prior art panning apparatus, the coating solution is typically a hot concentrated sugar solution, typically sucrose, having a temperature of at least about 80° C. Therefore, to apply dyes and colorants in such an apparatus, the ingredient must be stable at the temperature of the solution for extended periods of time, or the dye or colorant will degrade after extended exposure to the solution. If the dye or colorant is not stable at the temperature of the coating solution, the color obtained in the final coating may be significantly different from that desired. For example, although it takes about two hours at 90° C. to destroy about 40 to 60 percent of a sample of beet dye, which is also known as betanine or betalin, the beet dye degrades sufficiently to be unuseable in no more than about 10 minutes at 80° C. Moreover, it has been found that the acidity of a coating solution will also affect the color obtained from the dye. When exposed to a pH of 3.7, beet dye produces an orange color rather than the pink or purple desired, and when exposed to a pH of 7.3, the dye produces a dark color that is almost black. Therefore, heat sensitive colorants and dyes cannot be used in prior art panning processes in which the dye or colorant is mixed and stored with the hot coating solution before the application of the coating solution.

Therefore, a need exists for an apparatus and method to reduce the exposure of unstable ingredients to detrimental conditions in process solutions. The present invention provides such an apparatus and method.

### SUMMARY OF THE INVENTION

The present invention is directed to a process injection apparatus, to a method of introducing an unstable process ingredient into a process, and to a processing system incorporating the process injection apparatus of the invention with a process apparatus. The process injection apparatus of the invention comprises a process ingredient source and a process ingredient supply line. The process ingredient supply line has a first end and a second end, where the first end is in fluid communication with the process ingredient source, and the second end is configured and adapted for insertion into a process solution supply line of a process apparatus at a point upstream of a process vessel of the process apparatus, thereby providing an injection point in the process solution supply line. The process ingredient source and the injection point are in fluid communication through the process ingredient supply line, and the process injection apparatus is configured and adapted to supply a process ingredient from the process ingredient source, through the process ingredient supply line, and to the injection point for use in a process in the process vessel. The second end is configured to position the injection point sufficiently close to the process vessel, such that process ingredient flowing through the injection point is exposed to any process solution in the process apparatus for a period of time less than that required to significantly degrade the ingredient upon exposure to the solution. The invention is particularly useful where the process ingredient and the process solution must be mixed prior to introduction into the process, exposing the process ingredient to conditions that would degrade the ingredient over time.

In a preferred embodiment, the process injection apparatus is a coating ingredient injection apparatus for supplying a coating ingredient to a panning apparatus. The coating ingredient injection apparatus of the invention comprises a coating ingredient source and a coating ingredient supply line. The coating ingredient supply line has a first end and a second end, where the first end is in fluid communication with the coating ingredient source. The second end is configured and adapted for insertion into a coating solution supply line of a panning apparatus at a point upstream of a coating vessel of the panning apparatus, thereby providing an injection point in the coating solution supply line. The coating ingredient source and the injection point are in fluid communication through the coating ingredient supply line, and the coating ingredient injection apparatus is configured and adapted to supply a coating ingredient from the coating ingredient source and through the coating ingredient supply line to the injection point for use in a coating process in the coating vessel. The second end is configured to position the injection point sufficiently close to the coating vessel, such that coating ingredient flowing through the injection point is exposed to any coating solution in the panning apparatus for a period of time less than that required to significantly degrade the ingredient upon exposure to the solution.

The method of the invention comprises providing a process solution and a process ingredient for a process, wherein the process ingredient is unstable upon exposure to the process solution, connecting a process ingredient supply line to an injection point in a process solution supply line for the process, determining when process ingredient is required in the process, providing a flow of the required process ingredient through the process ingredient supply line into the process solution in the process solution supply line as the process solution flows through the process solution supply line to the process, and terminating the flow of the required process ingredient through the process ingredient supply line when an amount of the process ingredient sufficient for the process has been pumped to the process solution supply line. In the process of the invention, the process ingredient is exposed to the process solution for a period of time less than that required to significantly degrade or decompose the ingredient upon exposure to the solution.

### BRIEF DESCRIPTION OF THE DRAWINGS

FIG. 1 is a schematic of a panning apparatus incorporating a process injection apparatus of the invention;

FIG. 2 is an end view of an injection apparatus cart of the invention;

FIG. 3 is a side view of the injection apparatus cart of FIG. 2; and

FIG. 4 is a side view of the injection apparatus cart from the side opposite that illustrated in FIG. 2.

### DETAILED DESCRIPTION OF THE INVENTION

The present invention is directed to an apparatus and method for introducing an ingredient into a process solution as or shortly before the process solution containing the ingredient is required in a process. As used herein, the phrase “shortly before” means a period of time less than that period in which the ingredient would degrade or decompose in the process solution sufficiently to degrade the quality of the final product of the process. That is, before being used in the process, the process ingredient is exposed to the process solution for a period of time less than that required to significantly degrade the ingredient upon exposure to the solution. This is particularly useful in applications where the process ingredient and the process solution must be mixed prior to being introduced into the process.

As used herein, the phrases “significantly degrade” and “significant degradation” mean that the process ingredient is changed to a degree or in an amount that causes a detrimental change in the product prepared by the process. The change in the process ingredient may be the result of degradation, decomposition, or any other chemical and/or physical change that the process ingredient might experience during and/or after exposure to the process solution. A process ingredient that significantly degrades during and/or after exposure to the process solution is considered an unstable process ingredient. In a preferred embodiment of this invention, unstable product ingredients include certain dyes and/or colorants, and, in that case, the detrimental change would be a visually observable change in the color and/or appearance of coated centers after exposure of the dye and/or colorant to the process solution. Such visually observable change in the color and/or appearance include, but are not limited to, mottling, fading, or off-colors.

As used herein, the phrase “sufficiently close” means that the injection point is placed at a distance proximate to the process vessel that allows the process ingredient to be combined with the process solution without significantly degrading the process ingredient prior to processing, e.g., coating onto centers. One skilled in the art can readily determine this distance, which will be dependent on the process ingredient, the process solution, and the processing parameters, such as process solution temperature, pH, and flow rate, based on the disclosure herein and that known in the art without undue experimentation.

The invention is described and exemplified below in terms of applying a colored coating to a pill, tablet, piece of candy, or other center to be coated in, e.g., a panning apparatus, in which the process ingredient is a heat sensitive dye or colorant, and the process solution is a hot sugar solution used to coat centers. However, it will be understood by those skilled in the art that the method and apparatus of the invention may be used in other processes where the introduction of an unstable ingredient into a process solution prior to introduction of the solution and ingredient into the process using prior art methods would otherwise degrade or destroy the ingredient. The methods and apparatus of the invention allow the ingredient to be introduced into the process solution shortly before or as the process solution is introduced into the process, thereby allowing the use of the ingredient without significant degradation.

Certain colors, such as, e.g., purple and pink, are desirable in sugar coatings and shells for candy, pills, tablets, and the like. However, such colors are often difficult to obtain, in that the dyes and colorants presently available for producing such colors are unstable under the conditions that exist in coating process solutions, particularly the elevated temperatures of such solutions. As a result, when dyes and colorants, such as, e.g., anthocyanin and beet colorants, are used in a hot sugar coating solution, e.g., a sugar syrup at a temperature of at least about 80° C., the dye or colorants produce undesirable mottled, faded, or off-color coatings and shells. The discolorations arise from the extended exposure of the dye or colorant to the elevated temperature of the coating solution.

With the present invention, modifications to existing equipment are kept to a minimum, such that all existing syrup handling equipment and the pan may remain in place, and can be readily converted back to the original configuration. The only required change to the original equipment is the addition of an injection point in the coating solution line leading into the coating vessel. In addition, a mixer, such as, e.g., a static mixer, may optionally be placed into the coating solution line, downstream of the injection point. Preferably, the injection point is inserted as close to the coating vessel as possible to minimize exposure of the colorant or dye to the coating solution. This allows the use of natural colorants and dyes that are sensitive to the conditions that exist in a hot syrup application. The sugar syrup used in the process and apparatus of the invention preferably comprises sucrose. However, sugar syrups useful with the apparatus and process of the invention also include, but are not limited to, dextrose, maltose, high fructose corn syrup, and mixtures thereof.

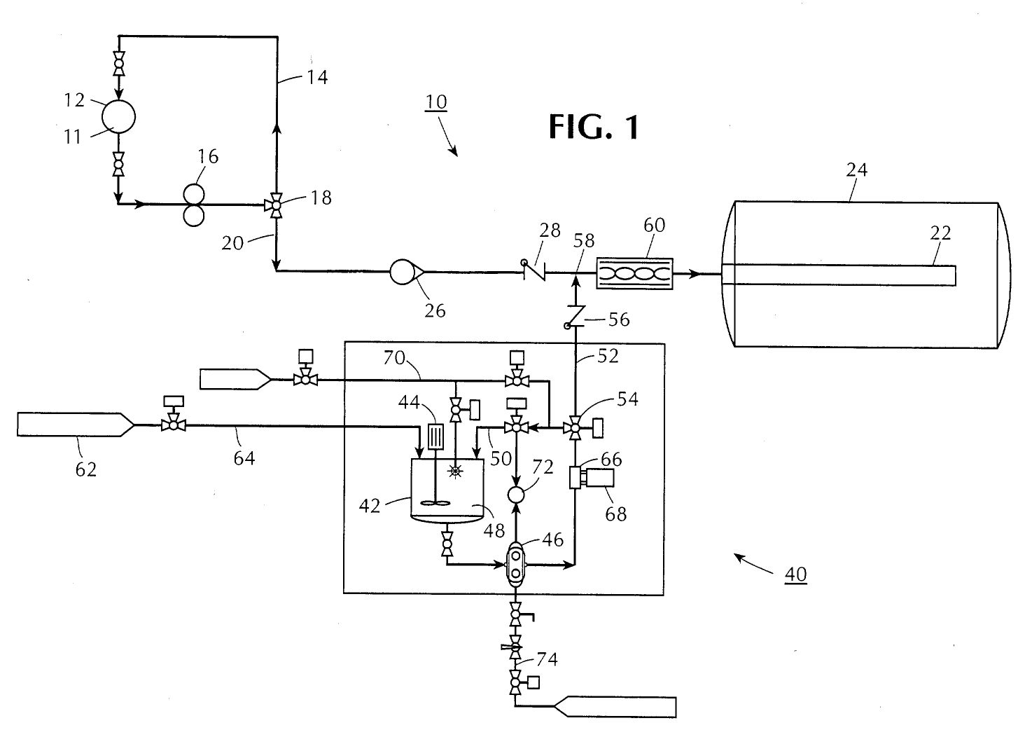

A preferred embodiment of the processing system of the invention, configured to provide a color slurry to a hot syrup 20 line in a panning apparatus 10 for forming a sugar shell is illustrated in FIG. 1. The main components of panning apparatus 10 are typical of those used in a coating apparatus today. However, as illustrated in FIG. 1, coating apparatus 10 is modified in accordance with the present invention by the addition of injection apparatus 40. As with prior art coating equipment, panning apparatus 10 comprises at least one hot syrup tank 12 in a recirculation loop 14. Hot syrup 11 from tank 12 is circulated through recirculation loop 14 by at least one pump 16 to maintain the temperature. When hot syrup 11 is required in the coating process, a three-way valve 18 diverts syrup from recirculation loop 14 to a syrup supply line 20 that transports syrup to the syrup application mechanism 22, preferably a spray manifold, in a coating pan or vessel 24.

A flow measuring device, in this embodiment, a flow meter, 26 in syrup supply line 20 preferably measures the flow rate of syrup in line 20. Signals from flow meter 26 are preferably used to control pump 16. A check valve 28 is also preferably inserted into supply line 20 to prevent back-flow of syrup in supply line 20.

To provide a colored shell in a prior art panning apparatus, hot syrup 11 must contain a colorant, which is exposed to the high temperature of the syrup for an extended period of time. Therefore, any colorant or dye used in a prior art apparatus must be stable in hot syrup 11. To form one or more colored layers, valve 18 is opened to allow hot syrup from recirculation loop 14 and tank 12 to flow into syrup supply line 20. Syrup in line 20 flows for a period of time sufficient to provide a sufficient amount of hot syrup 11 for a coating layer of the desired thickness, at which point valve 18 closes off the flow into line 20, and the coated centers are allowed to dry. Additional layers, if needed, are applied in the same manner.

The present invention differs from prior art coating equipment in that colorants or dyes that are unstable when exposed to the hot syrup for extended periods of time may be used without significant degradation. That is, the present invention introduces the colorant or dye into the hot syrup prior to introduction of the syrup into the coating apparatus, but limits the exposure of the colorant or dye to the hot syrup, such that no significant degradation occurs. Preferably, the invention may be used with hot syrup temperatures of from about 68° to about 100° C., more preferably from about 72° to about 95° C., and, most preferably from about 75° to about 90° C., with exposure times of up to about 10 minutes. Preferably the exposure time is from about 0.5 seconds to about 5 minutes, more preferably, from about 1 second to about 4.5 minutes, and, most preferably, from about 1.5 seconds to about 4 minutes.

As illustrated in FIG. 1, an injection apparatus 40, in accordance with the present invention, is used to minimize exposure of the colorant to hot syrup 11 in panning apparatus 10. Injection apparatus 40 comprises a color slurry tank 42, which functions as the ingredient source or tank, preferably containing a mixer 44, and a pump 46 that pumps color slurry 48 through either a slurry recirculation loop 50 or a slurry supply line 52, depending on the position of a 3-way valve 54. When valve 54 is in the slurry delivery position, color slurry flows through slurry supply line 52, which preferably includes a check valve 56 to prevent backflow, to syrup supply line 20. The color slurry enters supply line 20 at color slurry injection point 58, and is mixed with hot syrup 11 in line 20 in a static mixer 60. Static mixer 60 is preferably as close to syrup application mechanism 22 as possible to minimize exposure of color slurry 48 to hot syrup 11.

Cold syrup 62, having a sugar concentration of from about 66 Brix to about 68 Brix, is preferably introduced into color slurry tank 42 through color slurry line 64, and mixed with a dye or colorant by mixer 44 to form color slurry 48 having a temperature less than that at which the colorant significantly degrades or decomposes. The colorant concentration will vary, generally ranging from about 2.5 to about 24.6 percent by weight. When color slurry 48 is required to provide a coating of the desired color, valve 54 is placed in the slurry delivery position, allowing color slurry 48 to flow through slurry supply line 52 and a flow meter 66. Preferably, the timing of the opening of valve 54 and the opening of valve 18 are coordinated, such that color slurry 48 and hot syrup 11 are introduced at color slurry injection point 58 simultaneously for mixing in static mixer 60 and application by syrup application mechanism 22. Flow meter 66 measures the amount of color slurry 48 transported to syrup supply line 20. When the required amount of color slurry 48 has passed through flow meter 66, flow meter 66 sends a signal to valve 54, preferably, by transmitter 68. Valve 54 is changed to the recirculation position, and color slurry 48 flows through slurry recirculation loop 50.

Preferably, injection apparatus 40 also comprises a clean-in-place system 70 and a drain 72 for draining and cleaning the apparatus. To prevent the buildup of solids from color slurry 48 on the seal (not shown) of pump 46, the apparatus also preferably comprises a seal water system 74 that flows through pump 46 and into drain 72.

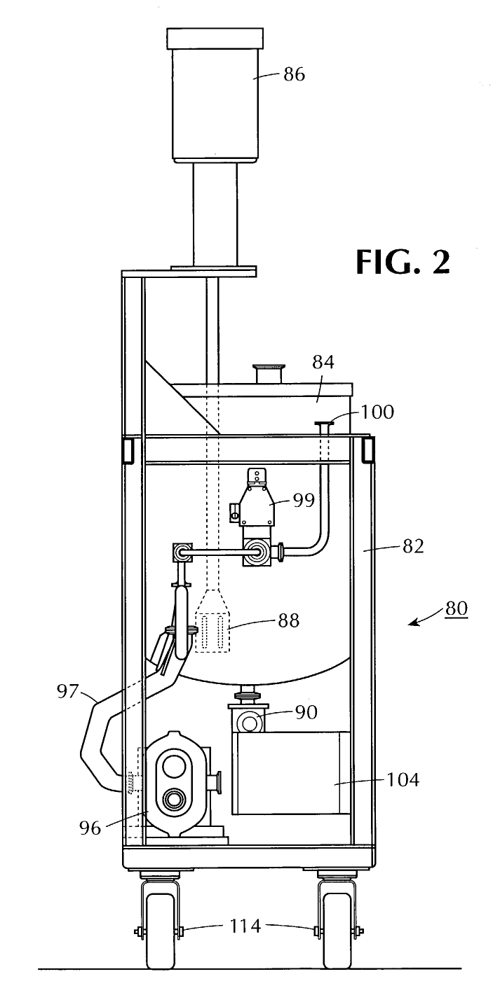

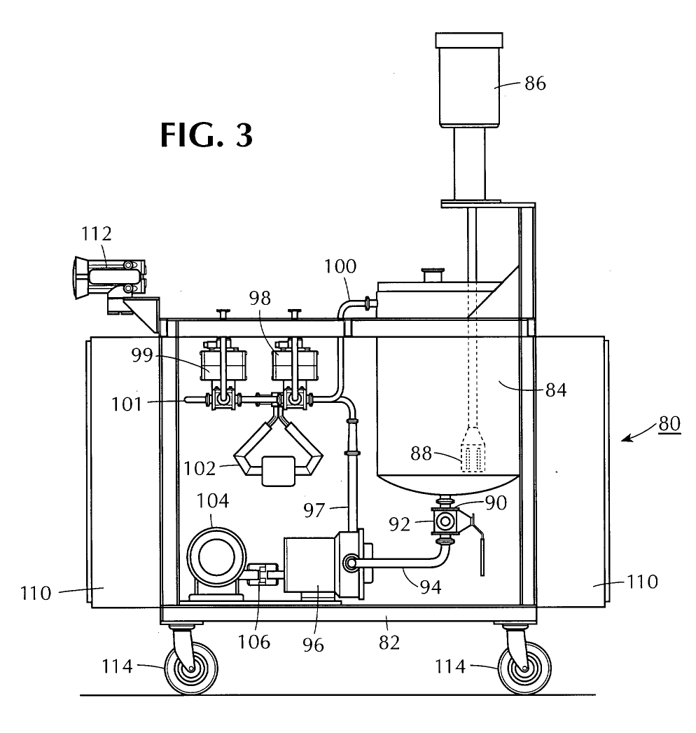

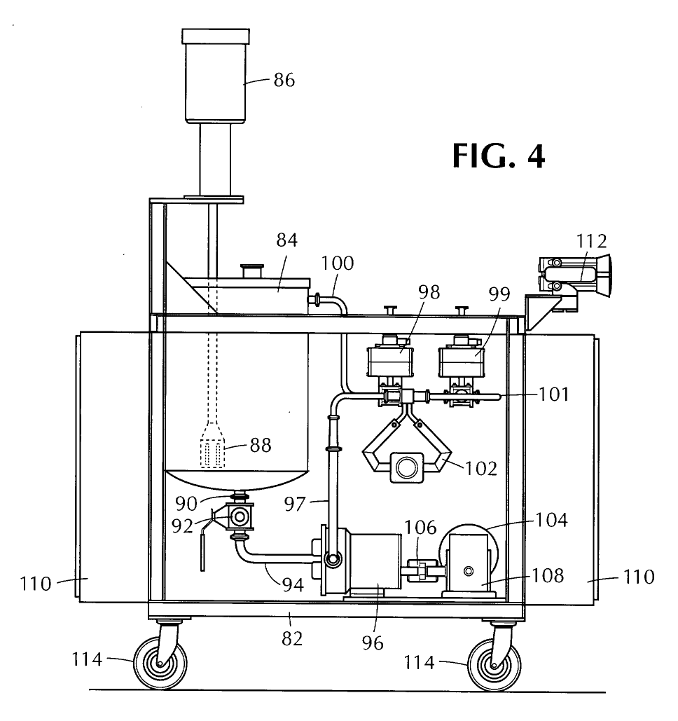

In a preferred embodiment, the injection apparatus is moveable, e.g., mounted on a cart that can be rolled to a process apparatus, and readily attached to a process solution line. This allows a single injection apparatus to be used on different pieces of equipment, as needed. For example, injection apparatus 40 may be attached to a panning apparatus when an unstable ingredient is used, and removed when the unstable ingredient is replaced with an ingredient that is stable under the process conditions. Such a cart, for use with, e.g., a color coating apparatus, is illustrated in FIGS. 2, 3, and 4, where FIG. 2 is an end view, and FIGS. 3 and 4 illustrate opposite sides. As will be recognized by those skilled in the art, use of the illustrated injection apparatus cart is not limited to color coating applications, but can be modified for use with other process applications, where extended exposure of one or more ingredients to a process solution must be avoided, without undue experimentation. As illustrated in FIGS. 2, 3, and 4, injection apparatus cart 80 comprises a cart frame 82 on which is mounted a blending tank 84 and a mixer 86, having a mixer head 88 positioned within blending tank 84 for blending a colorant with syrup to form a color slurry. An outlet 90 from blending tank 84, preferably controlled by a valve 92, is connected by a flow line 94 to a pump 96. Pump 96 pumps the color slurry through an output line 97 to a pair of 3-way valves 98 and 99, where valve 98 directs the flow to either a drain (not shown) or valve 99, and valve 99 directs the flow to either a recirculation loop 100, which returns the slurry to tank 84, or to a connection 101 to the coating apparatus (not shown). A flow meter 102 is placed in line with valves 98 and 99 to measure the rate of flow and the amount of color slurry that flows to the panning apparatus through connection 101. Pump 96 is driven by motor 104, preferably through a coupling 106, and, most preferably, through a reducer 108, which reduces the rotational speed of the motor 104 to the desired rotational speed of pump 96.

Preferably, the apparatus 80 is controlled by an electronics package 110, which functions as a process ingredient flow control mechanism. Preferably, electronics package 110 is connected to a transmitter 112. To provide the mobility needed to use apparatus 80 with different pieces of process equipment, apparatus 80 is preferably mounted on a set of wheels or castors 114. Signal from flow meters 26 and 66 may be used by electronics package 110 to control the ratio of the amount of color slurry 48 to hot syrup 11. The ratio of the amount of process ingredient, i.e., color slurry 48, to the amount of process solution, i.e., hot syrup 11, may be maintained at a substantially constant ratio or varied at a controlled rate. Preferably, where a substantially constant ratio is desired, any variation in the ratio is less than about 5 percent, more preferably, less than about 2 percent, and, most preferably, less than about 0.5 percent. As will be understood by those skilled in the art, greater variations in the ratio may occur for an insignificant period of time, i.e., significantly less than a second, at the beginning and end of an injection process. However, for the most part, the ratio of process ingredient to process solution is controlled sufficiently to maintain a substantially constant ratio as the ingredient is injected into the process solution.

### EXAMPLES

A prototype injection cart was fabricated with the basic components required for the apparatus, including a Bran and Leubbe piston pump, a ten-gallon tank with an Admix high shear mixer, a Micromotion CMF025 Coriolis flow meter, an automated ball valve, a check valve, and a static mixer. The injection point and the static mixer were inserted into the syrup supply line of a sugar shelling pan, and powdered beet colorant was mixed with 67 Brix sucrose syrup in the tank in an amount sufficient to form a solution having color concentration of about 24 percent by weight.

The panning cycle was started when the color slurry was completely mixed. Whenever a shot of syrup was requested by the pan, the cart was activated by opening and closing the appropriate valves to deliver the color slurry to a hot syrup having a temperature of about 80° C. The color slurry was mixed with hot syrup, and introduced into the pan and onto the candy. Evaporative cooling rapidly decreases the temperature of the coating solution below the degradation temperature of the colorant or dye. The flow meter monitored the flow rate of the color slurry to ensure that the proper amount of color was applied in each application. As a result, candy having a sugar shell with a vibrant purple color was obtained. This color could not be obtained by mixing the beet color directly with the hot syrup in the supply tank of the coating apparatus, as the colorant is unstable when exposed to the high temperature of the hot syrup for more than a few minutes. Using the injection cart minimized the exposure time of the colorant, such that stable colorant was applied to the candy.

Tests with piston, diaphragm, and rotary positive displacement pumps demonstrated that a rotary positive displacement pump was most capable of delivering high viscosity slurries, e.g. 60,000 cPs, to the hot syrup line. However, in a positive displacement pump, the lobe tolerances are greater for syrup than that required to pump water. As a result, as installed, the clean-in-place system for the pump is not sufficient. This problem was overcome by installing a pressurized hot water line after the pump to clean out the injection line.

In this embodiment, the color slurry flow rate is automatically controlled by varying the pump speed based on the difference between the flow rate required for a desired color concentration and the flow rate measured by the Coriolis flow meter. Where problems arise in keeping the colorant in solution, the size of the batch was increased to decrease the color concentration.

For a preferred apparatus of this invention, a liquid sugar solution, typically sucrose, having a concentration of about 76 Brix is typically stored at a temperature of 80°±2° C. in an 80 gallon tank. Maintaining the sugar solution at that temperature ensures that crystallization, which would occur at a temperature of about 68° C. or less, does not occur. The sugar solution may be pumped from the tank using a positive displacement pump at a constant pump speed. The flow rate of the sugar solution is typically dictated by the pump speed, which may be the same or different from product to product. However, the tank head pressure and product viscosity may also affect the flow rate, but such effects are typically negligible.

For a preferred embodiment of the present invention, the flow rate of sugar solution is preferably about 14 to about 22.7 liters per minute (lpm), i.e., about 3.7 to about 6 gallons per minute (gpm), and is measured using a rotating vane style flow meter. In such a coating apparatus, during the application of any given layer of the coating, the ratio of the amount of color slurry to the amount of sugar solution should be substantially constant to avoid variations and inconsistences in the colored coating. However, it will be recognized by those skilled in the art that the ratio of the amount of color slurry to the amount of sugar solution may be varied from application to application when desired. Therefore, the color density desired in the coating and the flow rate of the sugar solution required to produce a coating layer determines the flow rate required for the color slurry. Thus, the flow rate of the sugar solution is used to calculate the flow rate of color slurry. Preferably, the output of the flow meters in the sugar solution and color slurry supply lines are used to adjust the color slurry pump speed, thereby maintaining the flow rate of slurry at the level required for the desired ratio of color slurry to sugar solution. For a typical colored sugar shell, the ratio of color slurry to sugar solution is in the range of about 0.047 to about 0.139, depending on the desired color concentration and product recipe.

The temperature of the color slurry is greater than 23° C. to prevent crystallization, and is preferably about 25° to about 30° C. At the preferred flow rate, the colorant or dye is exposed to the hot syrup in the line for no more than about 2.2 seconds. Once the solution was introduced into the coating pan, the temperature dropped to no more than about 24° C. in a time sufficiently short to prevent the degradation of the colorant or dye, i.e., no more than a few seconds.

This invention is not limited by the embodiments disclosed herein, and it will be appreciated that numerous modifications and embodiments may be devised by those skilled in the art. Therefore, it is intended that the appended claims cover all such modifications and embodiments that fall within the true spirit and scope of the present invention.

What is claimed is:

1. A processing system for conducting a chemical or physical process, the processing system comprising:
a process apparatus and a process injection apparatus for supplying a process ingredient to the process apparatus, wherein the process apparatus comprises:
a process solution supply, a process vessel, and a process solution supply line, connecting the process solution supply and the process vessel; wherein
the process solution supply and the process vessel are in fluid communication through the process solution supply line, and the process apparatus is configured and adapted to supply process solution from the process solution supply and through the process solution supply line to the process vessel for processing; and
the process injection apparatus comprises:
a process ingredient source and a process ingredient supply line, the process ingredient supply line having a first end and a second end, the first end in fluid communication with the process ingredient source, and the second end configured and adapted to provide an injection point in the process solution supply line of the process apparatus at a point upstream of the process vessel; wherein
the process ingredient source and the process apparatus are in fluid communication through the process ingredient supply line and the injection point, and the process injection apparatus is configured and adapted to supply a process ingredient from the process ingredient source, through the process ingredient supply line and the injection point to the process apparatus for use in the process vessel; wherein
the injection point is sufficiently close to the process vessel that any process ingredient flowing through the injection point is exposed to any process solution in the process apparatus for a period of time less than that required to significantly degrade the ingredient upon exposure to the solution; and, optionally, wherein
the second end of the process ingredient supply line is configured and adapted to be disconnected and reconnected to the injection point, and the process injection apparatus is mobile, such that a single process injection apparatus can be used with more than one process apparatus.

2. The processing system according to claim 1, further comprising a process ingredient flow measuring device, configured to measure flow of the process ingredient flowing through the process ingredient supply line; and, optionally,
a process ingredient flow control mechanism in functional communication with the process ingredient flow measuring device, the process ingredient flow control mechanism configured and adapted to initiate flow of the process ingredient upon receipt of a signal that the process ingredient is required in the process vessel, and to terminate the flow upon receipt of a signal from the process ingredient flow measuring device that an amount of ingredient sufficient for the process has been pumped to the process apparatus.

3. The processing system according to claim 2, wherein the flow measuring device is a flow meter.

4. The processing system according to claim 1, further comprising a mixer positioned in the process solution supply line between the injection point and the process vessel.

5. The processing system according to claim 4, wherein the mixer is a static mixer.

6. The processing system according to claim 1, wherein the process is a panning process, and the process vessel is a coating pan.

7. The processing system according to claim 6, wherein the process solution is a sucrose coating solution.

8. The processing system according to claim 1, wherein the process ingredient is a temperature sensitive colorant or dye.

9. The processing system according to claim 8, wherein the colorant or dye is anthocyanin or a beet dye.

10. The processing system according to claim 1, further comprising at least one valve in the process ingredient supply line, the valve having a supply position and a recirculation position, wherein, when the valve is in the supply position, the process ingredient flows from the source to the pump and through the valve to the injection point, and, when the valve is in the recirculation position, the process ingredient flows from the source to the pump and back to the source, thereby forming a recirculation loop; and, optionally
a process ingredient flow control mechanism in functional communication with the at least one valve, the process ingredient flow control mechanism configured and adapted to place the valve in the supply position upon receipt of a signal that the process ingredient is required in the process vessel, and to place the valve in the recirculation position upon receipt of a signal that an amount of ingredient sufficient for the process has been pumped to the process apparatus.

11. The processing system according to claim 1, further comprising a mixer placed in the ingredient source, and configured to mix process ingredient in the ingredient source.

12. The processing system according to claim 1, further comprising a pump configured and adapted to pump process ingredient from the process ingredient source, through the process ingredient supply line and the injection point to the process apparatus.

13. The processing system according to claim 12, wherein the pump is a piston, diaphragm, or rotary positive displacement pump.

14. A method of introducing a process ingredient unstable in a process solution of a process into the process without significant degradation of the process ingredient, the method comprising:
providing a process solution and a process ingredient for a process, wherein the process ingredient is unstable upon exposure to the process solution;
connecting a process ingredient supply line to an injection point in a process solution supply line for the process;
determining when process ingredient is required in the process;
providing a flow of the required process ingredient through the process ingredient supply line into the process solution in the process solution supply line as the process solution flows through the process solution supply line to the process;
terminating the flow of the required process ingredient through the process ingredient supply line when an amount of the process ingredient sufficient for the process has been pumped to the process solution supply line;
exposing the process ingredient to the process solution for a period of time less than that required to significantly degrade the ingredient upon exposure to the solution;
optionally, flowing the process ingredient through a recirculation loop when the process ingredient is not required in the process; and, optionally
mixing the ingredient with the process solution in the process solution supply line with a mixer positioned in the process solution supply line.

15. The method of claim 14, wherein the process is a panning process.

16. The method of claim 22, wherein the process solution is a sucrose coating solution.

17. The method of claim 14, wherein the process ingredient is a dye or colorant.

18. A coating system for applying a coating to a mass of centers, the coating system comprising:
a coating apparatus and a coating ingredient injection apparatus, wherein the coating apparatus comprises:
a coating solution supply, a coating vessel, and a coating solution supply line, connecting the coating solution supply and the coating vessel; wherein
the coating solution supply and the coating vessel are in fluid communication through the coating solution supply line, and the coating apparatus is configured and adapted to supply coating solution from the coating solution supply, through the coating solution supply line, and to the coating vessel for coating a mass of centers; and
the coating ingredient injection apparatus comprises:
a coating ingredient source and a coating ingredient supply line, the coating ingredient supply line having a first end and a second end, the first end in fluid communication with the coating ingredient source, and the second end in fluid communication with an injection point of the coating apparatus positioned in the coating solution supply line at a point upstream of the coating vessel; wherein
the coating ingredient source and the coating apparatus are in fluid communication through the coating ingredient supply line and the injection point, and the coating injection apparatus is configured and adapted to supply a coating ingredient from the coating ingredient source, through the coating ingredient supply line and through the injection point to the coating apparatus for use in the coating vessel; and wherein
the injection point is sufficiently close to the coating vessel that coating ingredient flowing through the injection point is exposed to any coating solution in the coating apparatus for a period of time less than that required to significantly degrade the coating ingredient upon exposure to the coating solution.

19. The coating system according to claim 18, wherein the coating ingredient is anthocyanin or a beet dye.

20. A coating ingredient injection apparatus for supplying a coating ingredient to a panning apparatus, the coating ingredient injection apparatus comprising:
a coating ingredient source and a coating ingredient supply line, the coating ingredient supply line having a first end and a second end, the first end in fluid communication with the coating ingredient source, and the second end configured and adapted for insertion into a coating solution supply line of a panning apparatus at a point upstream of a coating vessel of the panning apparatus, thereby providing an injection point in the coating solution supply line; wherein
the coating ingredient source and the injection point are in fluid communication through the coating ingredient supply line, and the coating ingredient injection apparatus is configured and adapted to supply a coating ingredient from the coating ingredient source and through the coating ingredient supply line to the injection point for use in a coating process in the coating vessel; and wherein
the second end is configured to position the injection point sufficiently close to the coating vessel, such that coating ingredient flowing through the injection point is exposed to any coating solution in the panning apparatus for a period of time less than that required to significantly degrade the ingredient upon exposure to the solution.
